(19) United States
(12) Patent Application Publication
(10) Pub. No.: US 2014/0174311 A1
(43) Pub. Date: Jun. 26, 2014

(54) DOCTOR BLADE

(71) Applicant: Allan Lunnerfjord, Munkfors (SE)

(72) Inventor: Allan Lunnerfjord, Munkfors (SE)

(21) Appl. No.: 14/235,457

(22) PCT Filed: Aug. 3, 2012
(86) PCT No.: PCT/SE2012/050858

§ 371 Date: Jan. 28, 2014

(30) Foreign Application Priority Data
Aug. 4, 2011 (SE) 1150730-8

(51) Int. Cl. B41F 9/10

(52) U.S. Cl. CPC B41F 9/10
USPC 101/157

(57) ABSTRACT

A doctor blade has a strip shaped body (2) and at least one thinned edge with a first wearing section which has the shape of a lamella. It is a characteristic feature that the thinned edge has a second wearing section (13) in a region between the first wearing section and the body of the doctor blade at a distance from the first wearing section, and that the second wearing section is thicker than the first one, that between them there is a transition section (14) which has a width which is not more than 5% of the total width (FB) of the thinned edge square to the longitudinal direction of the doctor blade, in which transition section the thickness steeply increases from the thickness of the lamella shaped section adjacent to the transition section to the thickness of the second wearing section adjacent to the transition section.

### TECHNICAL FIELD

The present invention relates to a doctor blade made of steel, other alloy or metal, with a strip shaped body with flat, parallel sides and at least one longitudinal edge portion with reduced thickness including a first wearing section which has the shape of a lamella.

### BACKGROUND OF THE INVENTION

FIG. 1 in the accompanying drawings shows a doctor blade of the above mentioned kind in cross section. The doctor blade has a body 2 to be clamped in a holder 7, which is shown schematically in FIG. 3 but is omitted in FIG. 2 and FIG. 4, and a thinned, more specifically beveled edge with a lamella shaped wearing section 3. In a transition section 4 of the blade, there is a concave, smooth transition 5 between the lamella 3 and the blade body 2, ending with a sharp edge 6 in a border line against the blade body. The assembly which is schematically illustrated in FIG. 2 is employed in rotogravure printing processes for scraping off excess printing ink from an engraved printing cylinder 8 or anilox roll. The lamella shaped wearing portion 3 of the doctor blade 1 is pressed at a certain angle against the cylinder 8, while the assembly consisting of the holder 7 and the doctor blade 1 oscillates sideways to and fro. The doctor blade 1 is somewhat longer than the cylinder 8. It has, to a great deal due to the geometry of the thinned edge portion, very good qualities in terms of the results which are achieved in connection with the scraping off the excess printing ink from the engraved printing- or anilox cylinder, provided it is made of a steel or other material of good quality and is hardened to an adequate hardness and has an edge which is shaped with high precision.

However, it has turned out that the doctor blade is more severely worn in those parts X which repeatedly pass the ends of the rotating cylinder 8 as the doctor blade oscillates to and fro, than in the central main part of the blade—section L1—which is the part that scrapes off the excess printing ink from the corresponding part of the cylinder 8, from which the printing ink shall be transferred to the matter to be printed. The lamella shaped portion 3 therefor often works very well, even if those parts of the end sections L2, which oscillate to and fro in the region of the ends of the cylinder, have been worn down beyond the transition section 4 to a distance into the blade body 2. It is true that this impairs the scraping off of excess printing ink in the end parts of the cylinder, but that is not any great trouble, as those parts of the cylinder are not printing parts. What is serious, however, is that the heavy wear and/or the fissure formation which can be observed in the heavily worn down parts X of the doctor blade, may cause leakage of printing ink, such that printing ink will spray around, a condition which is unacceptable. In that case, the doctor blade must be rejected, even though the main part of the doctor blade, which may have a length of up to three meters, still would be useful, while the damaged parts typically have a length of just 20-30 mm. To some extent, the problem can be attended to by hardening the doctor blade to a lower hardness. This reduces the formation of fissures but instead makes the lamella shaped wearing section 3 less resistant to wear, which in turn shortens the service life of the doctor blade. It is also known that the problem to some, but not to a desired extent, can be attended to by cutting off those corners of the ends of the doctor blade which comprise the lamella edge.

### BRIEF DISCLOSURE OF THE INVENTION

It is the purpose of the invention to address the above complex of problems and to provide a doctor blade having a sound and long useful life and constantly good quality. This can be achieved therein that the invention is characterized by what is stated in the appending claims. Further characteristic features and aspects of the invention will be disclosed in the following detailed description of some preferred embodiments.

### BRIEF DESCRIPTION OF DRAWINGS

In the accompanying drawings,

FIG. 1 shows a doctor blade in cross section, which has a known profile, comprising a lamella shaped wearing portion,

FIG. 2 schematically illustrates how the doctor blade, which is mounted in a holder, contacts a rotational printing cylinder,

FIG. 3 shows the assembly of FIG. 2 as viewed in the direction of arrow III,

FIG. 4 shows the encircled portion of the doctor blade in the region of one end of the printing roller at an enlarged scale,

FIG. 5 shows a cross section of a doctor blade according to a first conceivable embodiment of the invention, and

FIG. 6 shows a cross section of a doctor blade according to a second conceivable embodiment of the invention.

### DETAILED DESCRIPTION OF THE INVENTION

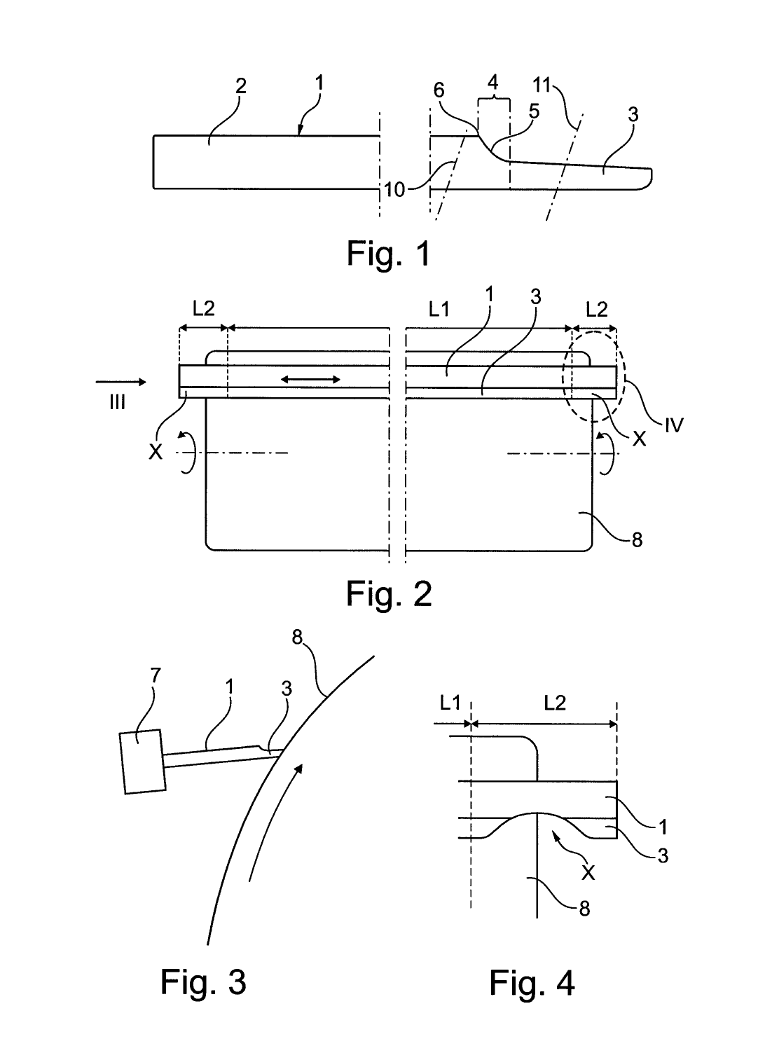

The complex of problems which the invention aims to address has been described briefly in the introductory description of the invention's background. FIG. 4 shows an example of how the prior art doctor blade 1 is worn in the region of the ends of the printing cylinder 8—one of the ends is indicated by the ring IV—so heavily that the lamella shaped wearing portion 3 has been completely consumed in the region, and so that the doctor blade has been worn down all the way to and into the blade body 2. The depth of wear in this end region is indicated by the arrow 10 in FIG. 1. At the same time, the lamella shaped wearing portion 3 has been worn only slightly along the main part of the doctor blade, e.g. down to that depth which is indicated by the arrow 11. In the ideal case, the wearing of the doctor blade down into the blade body 2 in the end regions of the printing cylinder should not cause any problem, since the end portions of the printing cylinder are not utilized for printing, which means that a less efficient scraping off of printing ink in that region could be tolerated. However, in some cases the type of defect can arise which is illustrated in FIG. 4, i.e. that openings or fissures are formed in the doctor blade, through which printing ink could pass by and splash around. In that case the whole doctor blade 1 must be rejected prematurely, i.e. long before the whole lamella 3 has been worn down.

The reasons to the said formation of fissures and/or to the wearing down of the doctor blade into the region of the of its body are not clearly elucidated, but a possible reason may be that the blade body 2, i.e. the base material of the doctor blade 1, is considerably stiffer than the more resilient lamella shaped wearing section 3. Therefore, when the wearing of the doctor blade in the end regions of the printing cylinder has reached the sharp edge 6, FIG. 1, significantly large compressive forces arise in the first place in the breadth direction of the blade. This is believed to be the reason for such phenomena as local overheating of the doctor blade in the end regions of the printing cylinder, local hardening, precipitation of very hard phases, embrittlement, fatigue, etc. which in turn could cause formation of fissures and destruction. Without binding the invention to this theory, a few modifications of the thinned edge portion of the doctor blade are suggested according to the invention, i.e. of that edge portion, the material volume of which through chamfering or in other mode has been reduced prior to start using the doctor blade, all of which is for the purpose that the damaging, compressive forces in the breadth direction of the doctor blade shall not be developed to any essential degree before the lamella shaped portion has been consumed completely or to a substantial degree.

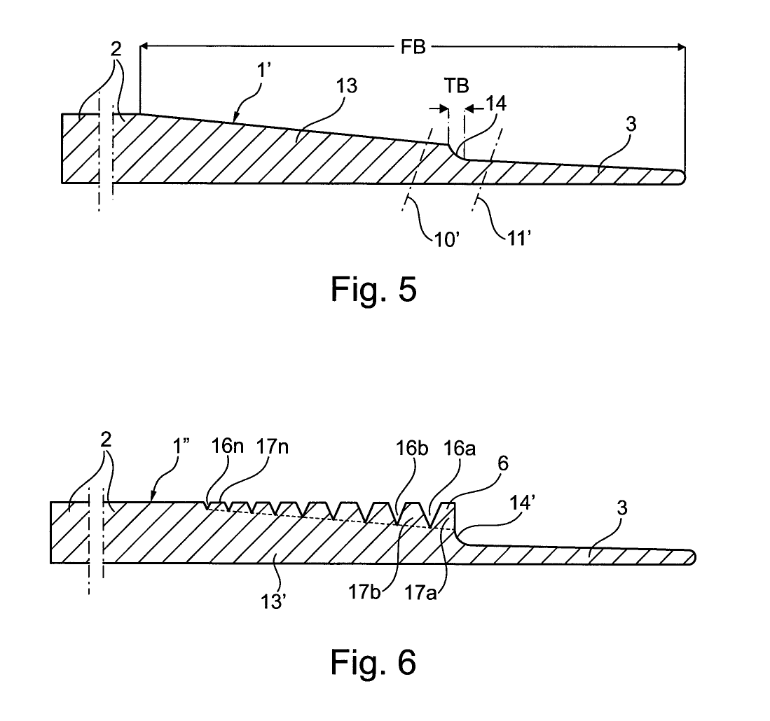

As far as the prior art doctor blade 1 of FIG. 1 is concerned, the width of the edge portion consists of the width of the lamella shaped wearing portion 3 plus the width of a transition section 4, i.e. the width between the tip of the lamella 3 and the sharp edge 6. In the embodiment according to the invention, which is illustrated in FIG. 5, the width of the thinned portion, which is designated F5, is more extended and comprises a first wearing section which is lamella shaped and may have the same width, thickness and geometry as the lamella 3 of the prior art doctor blade 1 and therefor has been afforded the same reference numeral 3 as said lamella, and a second, wider wearing section 13.

Between said first and second wearing sections 3 and 13, there is a transition section 14. The total width FB of the thinned edge, i.e. the total width of the lamella shaped portion 3, the transition section 14, and the second wearing section 13, shall be 2-10 mm according to an aspect of the invention. Further, according to another aspect of the invention, the width LB of the first wearing section 3 shall amount to not more than 50% of the total width FB of the thinned edge. The lamella 3 is slightly wedge-shaped according to the embodiment, i.e. its thickness increases from the tip towards the transition section 14, however not necessarily linearly. The incline rising gradient is 0.02/1 according to the embodiment. Depending on i.a. the hardness of the steel, the inclination may vary in order to afford a desirable springiness to the lamella. The upper and lower sides of the lamella may also be parallel, as according to the embodiment shown in FIG. 6, which means that the lamella 3 is not wedge-shaped. The width TB of the transition section amounts to about 5% of the thinned edge width FB. The inclination of the second wearing section 13, i.e. its thickness increase per width unit, is 0.2/1. This may also be expressed tg β=0.2, where β is the angle of inclination of the wearing section 13. The size of the angle of inclination a of the lamella 3 may correspondingly be expressed tg α=0.02.

Through adaptation of the lamella width LB to the total width of the thinned edge, an adequate springiness of the lamella 3 and of the entire thinned region FB can be achieved for the provision of desired features of the doctor blade 1′ for the scraping off of printing ink, in combination with a certain springiness and flexibility also of the second wearing section 13 so that, when the first wearing section/the lamella 3 has been consumed so far that the surface of the lamella 3 which contacts the printing cylinder 8—corresponding to the line 11′'approaches the transition section 14 along the main section of the printing cylinder where the transfer of printing ink is taking place, the wear of the doctor blade in the regions of the end sections of the printing cylinder has advanced a distance into the second wearing section 13, represented by the line 10′. Owing to the geometry, that section has a sufficient flexibility, or other features, which essentially prevent changes in the material of the type mentioned in the foregoing, such as considerable local hardening, precipitation of hard phases, formation of fissures, or the like. In other words, the undesired splashing of printing ink can be avoided right until the wear of the lamella along the said main part of the printing cylinder has proceeded down to, or at least substantially down to, the base of lamella 3 adjacent to the transition section 14.

The embodiment of the doctor blade 1″ according to FIG. 6 differs from that according to FIG. 5 with respect to the design of the second wearing section 13′, which is neither beveled, as according to the embodiment of FIG. 5, or evenly thinned, but is provided with a number of longitudinal, parallel grooves 16a, 16b, etc, the depths of which increase from the first groove 16a close to the sharp edge 6 till the last groove 16n at the end of the wearing section 13′. In this case it is the mean thickness of the second wearing section 13′ that is reduced successively from the edge 6. The grooves 16a, 16b, . . . 16n increase the flexibility of the wearing section 13′, while the bars 17a, 17b, 17c, . . . 17n between the grooves increase the stiffness of the wearing section in the longitudinal direction of the doctor blade 1″. The transition section between the wearing section 13′ and the first bar 6 is designated 14′. The embodiment in other words combines two desired features of the doctor blade. The provision of the grooves, which are characteristic features of this embodiment, may also be combined with those principles which are characteristic for the foregoing embodiment.

1-13. (canceled)

14. A doctor blade made of steel, other alloy or metal, with a strip shaped body with flat, parallel sides and at least one longitudinal edge portion with reduced thickness including a first wearing section which has the shape of a lamella, wherein the edge portion with reduced thickness includes a second wearing section in a region between said first wearing section and said blade body at a distance from the first wearing section, that the second wearing section is thicker than the first one, that between the first and the second wearing section there is a short transition section which has a width that is not more than 5% of the total width of said edge portion with reduced thickness in a direction square to the longitudinal direction of the doctor blade—in this context referred to as thinned edge width (FB)—the thickness of the transition section rising steeply from the thickness of the lamella shaped first wearing section adjacent to the transition section to the thickness of the second wearing section adjacent to the transition section, in that the thickness of the lamella shaped wearing section increases from a thickness adjacent to the tip of the lamella to a second, larger thickness at the inner end of the lamella shaped wearing section, and in that the thickness of the second wearing section increases from a third thickness, which is larger than said second thickness, to a fourth thickness which is the thickness of the blade body.

15. The doctor blade according to claim 14, wherein the width of the thinned edge portion (FB), which is the total width of the edge portion that has a reduced thickness, square to the longitudinal direction of the doctor blade, is at least 2 mm but not more than 10 mm.

16. The doctor blade according to claim 15, wherein a first lamella shaped wearing section has a width—in the context referred to as lamella width—which amounts to not more than 50% of the width of the thinned edge portion.

17. The doctor blade according to claim 15, wherein a first lamella shaped wearing section has a width—in the context referred to as lamella width—which amounts to not more than 30% of the width of the thinned edge portion.

18. The doctor blade according to claim 14, wherein the transition section has a width which amounts to not more than 10% of the width of the thinned edge portion.

19. The doctor blade according to claim 18, wherein the transition section has a width which amounts to not more than 5% of the width of the thinned edge portion.

20. The doctor blade according to claim 18, wherein the transition section has a width of at least 0.05 mm but not more than 0.2 mm.

21. The doctor blade according to claim 14, wherein thickness of the second wearing section increases in a direction from the transition section towards the blade body, and that the mean thickness increase of the second wearing section per width unit is larger than the mean thickness increase of the lamella shaped wearing section per width unit in a direction from the tip of the lamella towards the transition section.

22. The doctor blade according to claim 14, wherein the thickness of the lamella shaped wearing section at an average increases 0.01-0.03 mm per millimeter of the width.

23. The doctor blade according to claim 22, wherein the thickness of the lamella shaped wearing section at an average increases 0.015-0.025 mm per millimeter of the width.

24. The doctor blade according to claim 14, wherein the second wearing section at an average increases between 10 and 300% more per width unit than the first one does.

25. The doctor blade according to claim 14, wherein the thickness of the second wearing section increases towards the doctor blade body through a number of parallel groove extending in the longitudinal direction of the doctor blade, the depths of said grooves successively decreasing along the width of said second wearing section in a direction towards the doctor blade body.

26. The doctor blade according to claim 14, wherein any of, both, or all the thinned sections has a side surface which is on level with the corresponding side surface of the blade body.

27. The doctor blade according to claim 14, wherein it has a thickness of 0.1-0.5 mm.
